(19) United States
(12) Patent Application Publication
(10) Pub. No.: US 2020/0341953 A1
(43) Pub. Date: Oct. 29, 2020

(54) MULTI-NODE DEDUPLICATION USING HASH ASSIGNMENT

(71) Applicant: EMC IP Holding Company LLC, Hopkinton, MA (US)

(72) Inventors: Uri Shabi, Tel Mond (IL); Maor Rahamim, Ramla (IL); Ronen Gazit, Tel Aviv (IL)

(21) Appl. No.: 16/397,065

(22) Filed: Apr. 29, 2019

(51) Int. Cl. G06F 16/215; G06F 16/22

(52) U.S. Cl. CPC G06F 16/215; G06F 16/2255

(57) ABSTRACT

A method of performing deduplication is provided. The method includes (a) applying an ownership model in assigning digest values to processing nodes configured for active-active writing to a storage object by performing an operation that distinguishes a first class of digest values from a second class of digest values, the first class of digest values assigned to a first processing node and the second class of digest values assigned to a second processing node; (b) performing deduplication lookups by the first processing node for digest values belonging to the first class; and (c) directing the second processing node to perform deduplication lookups for digest values belonging to the second class. An apparatus, system, and computer program product for performing a similar method are also provided.

### BACKGROUND

Data storage systems are arrangements of hardware and software in which storage processors are coupled to arrays of non-volatile storage devices, such as magnetic disk drives, electronic flash drives, and/or optical drives. The storage processors service storage requests arriving from host machines (“hosts”), which specify blocks, files, and/or other data elements to be written, read, created, deleted, etc. Software running on the storage processors manages incoming storage requests and performs various data processing tasks to organize and secure the data elements on the non-volatile storage devices.

Some storage systems support data “deduplication.” A common deduplication scheme involves replacing redundant copies of a data block with pointers to a single retained copy. Data deduplication may operate in the background, after redundant data blocks have been stored, and/or operate inline with storage requests. Inline deduplication matches newly arriving data blocks with previously-stored data blocks and configures pointers accordingly, thus avoiding initial storage of redundant copies.

A common deduplication scheme involves computing digests of data blocks and storing the digests in a database. Each digest is computed as a hash of a data block's contents and identifies the data block with a high level of uniqueness, even though the digest is typically much smaller than the data block itself. Digests thus enable block matching to proceed quickly and efficiently, without having to compare blocks byte-by-byte. For each digest, the database stores a pointer that leads to a stored version of the respective data block. To perform deduplication on a particular candidate block, a storage system computes a digest of the candidate block and searches the database for an entry that matches the computed digest. If a match is found, the storage system arranges metadata of the candidate block to point to the data block that the database has associated with the matching digest. In this manner, a duplicate copy of the data block is avoided.

### SUMMARY

Conventional deduplication schemes may operate sub-optimally when multiple processing nodes are used to process incoming writes in an active-active manner. Active-active systems allow hosts to access the same data elements via multiple processing nodes.

In some systems, two processing nodes may share access to the same digest database. In order to avoid contention, locking mechanisms may be used, but locking can slow down operation of the system. In order to avoid such slowdowns, each processing node may maintain its own separate digest database for any incoming writes that it processes. In such systems, however, opportunities to deduplicate data blocks may be missed, e.g., if a digest entry for a block appears in the digest database on the other node but not on the node receiving the write. Also, the total amount of memory needed to support deduplication, when considered across both nodes, is much larger than what is minimally required.

Thus, it would be desirable to operate an active-active system employing deduplication in a manner that avoids these deficiencies. This may be accomplished by applying an ownership model that deterministically assigns digests to particular processing nodes. Upon receiving any new block for ingest, a processing node hashes it to produce a digest and determines, in accordance with the ownership model, whether it is the owner of that digest or some other node is the owner. If the processing node owns the digest, it looks up the digest in a shared digest database and continues performing deduplication on the block based on what is found in the database. If the processing node is not the owner of the digest, that processing node instead forwards the digest to another processing node that is the owner. That other processing node then looks up the digest in the shared digest database. In this fashion, the workload associated with digest lookups is divided among the processing nodes in accordance with the ownership model. Each node is permitted to limit its cached digests to only those digests for which it is the owner, thus reducing memory utilization overall. A further improvement can be made by dynamically modifying the ownership model to account for changing processor availability of the various processing nodes. Another improvement can be made by accumulating several digests to be forwarded until a memory page has been filled with such digests, allowing for efficient communications between the processing nodes.

In one embodiment, a method of performing deduplication is provided. The method includes (a) applying an ownership model in assigning digest values to processing nodes configured for active-active writing to a storage object by performing an operation that distinguishes a first class of digest values from a second class of digest values, the first class of digest values assigned to a first processing node and the second class of digest values assigned to a second processing node; (b) performing deduplication lookups by the first processing node for digest values belonging to the first class; and (c) directing the second processing node to perform deduplication lookups for digest values belonging to the second class. An apparatus, system, and computer program product for performing a similar method are also provided.

The foregoing summary is presented for illustrative purposes to assist the reader in readily grasping example features presented herein. However, the foregoing summary is not intended to set forth required elements or to limit embodiments hereof in any way.

### BRIEF DESCRIPTION OF THE SEVERAL VIEWS OF THE DRAWINGS

The foregoing and other features and advantages will be apparent from the following description of particular embodiments of the invention, as illustrated in the accompanying drawings, in which like reference characters refer to the same or similar parts throughout the different views.

FIG. 1 is a block diagram depicting an example system and apparatus for use in connection with various embodiments.

FIG. 2 is a flowchart depicting example methods of various embodiments.

FIG. 3 is a flowchart depicting an example method of various embodiments.

### DETAILED DESCRIPTION OF THE INVENTION

Embodiments are directed to techniques for operating an active-active system employing deduplication in a manner that avoids deficiencies both due to locking and reduced storage efficiency. This may be accomplished by applying an ownership model that deterministically assigns digests to particular processing nodes. Upon receiving any new block for ingest, a processing node hashes it to produce a digest and determines, in accordance with the ownership model, whether it is the owner of the digest or some other node is the owner. If the processing node owns the digest, it looks up the digest in a shared digest database and continues performing deduplication on the block based on what is found in the database. If the processing node is not the owner of the digest, that processing node instead forwards the digest to another processing node that is the owner. That other processing node then looks up the digest in the shared digest database. In this fashion, the workload associated with digest lookups is divided among the processing nodes in accordance with the ownership model. Each node is permitted to limit its cached digests to only those digests for which it is the owner, thus reducing memory utilization overall. A further improvement can be made by dynamically modifying the ownership model to account for changing processor availability of the various processing nodes. Another improvement can be made by accumulating several digests to be forwarded until a memory page has been filled with such digests, allowing for efficient communications between the processing nodes.

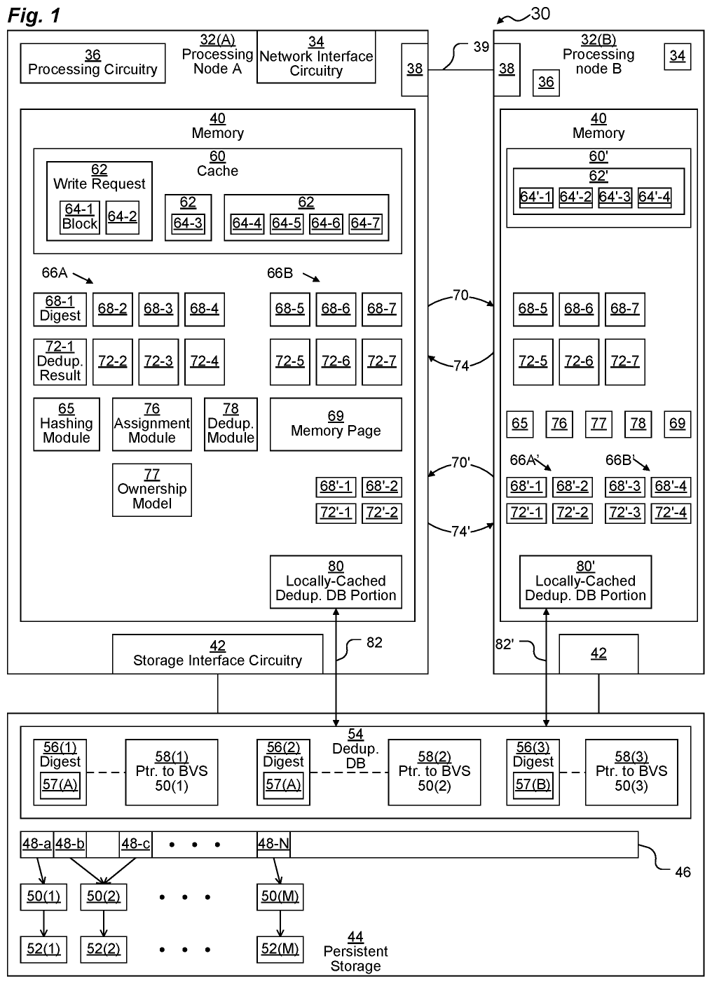

FIG. 1 depicts an example data storage environment (DSE) 30. DSE 30 may be any kind of computing device or collection (or cluster) of computing devices, such as, for example, a personal computer, workstation, server computer, enterprise server, data storage array device, laptop computer, tablet computer, smart phone, mobile computer, etc.

DSE 30 includes at least two processing nodes 32 and shared persistent storage 44. As depicted, two processing nodes 32(A), 32(B) are used, although greater than two processing nodes 32 may be used. In some embodiments, all processing nodes 32 are located within the same enclosure (e.g., within a single data storage array device), while in other embodiments, one or more processing nodes 32 may be located within multiple enclosures, which may be connected by a network (e.g., a LAN, a WAN, the Internet, etc.).

In some embodiments, each processing node 32 may be configured as a circuit board assembly or blade which plugs into a chassis that encloses and cools the processing nodes and attached storage. The chassis has a backplane for interconnecting the processing nodes 32 and persistent storage 44, and additional connections may be made among processing nodes 32 using cables. In some examples, a processing node 32 is part of a storage cluster, such as one which contains any number of storage appliances, where each appliance includes a pair of processing nodes 32 connected to persistent storage 44. No particular hardware configuration is required, however, as any number of processing nodes 32 may be provided, and the processing nodes 32 can be any type of computing devices capable of running software and processing host I/Os.

Each processing node 32 may include network interface circuitry 34, processing circuitry 36, node interconnection circuitry 38, memory 40, and storage interface circuitry 42. Each processing node 32 may also include other components as are well-known in the art.

Network interface circuitry 34 may include one or more Ethernet cards, cellular modems, Fibre Channel (FC) adapters, Wireless Fidelity (Wi-Fi) wireless networking adapters, and/or other devices for connecting to a network (not depicted). Network interface circuitry 34 allows each processing node 32 to communicate with one or more host devices (not depicted) capable of sending data storage commands to the DSE 30 over the network. In some embodiments, a host application may run directly on a processing node 32.

Processing circuitry 36 may be any kind of processor or set of processors configured to perform operations, such as, for example, a microprocessor, a multi-core microprocessor, a digital signal processor, a system on a chip, a collection of electronic circuits, a similar kind of controller, or any combination of the above.

Node interconnection circuitry 38 may be any kind of circuitry used to effect communication between the processing nodes 32 over an inter-node communications link 39 (such as, for example, an InfiniBand interconnect, a Peripheral Component Interconnect, etc.) to connect the processing nodes 32.

Persistent storage 44 may include any kind of persistent storage devices, such as, for example, hard disk drives, solid-state storage devices (SSDs), flash drives, etc. Storage interface circuitry 42 controls and provides access to persistent storage 44. Storage interface circuitry 42 may include, for example, SCSI, SAS, ATA, SATA, FC, M.2, and/or other similar controllers and ports.

Persistent storage 44 may be logically divided into a plurality of data structures, including a logical address mapping layer 46 (including a set of mapping pointers 48 that represent logical addresses), a set of block virtualization structures (BVSes) 50 (depicted as BVSes 50(1), 50(2), . . . , 50(M)), a set of data extents 52 (depicted as extents 52(1), 52(2), . . . , 52(M)), and a deduplication database (DB) 54. Logical address mapping layer 46 may be structured as a sparse address space that allows logical block addresses to be mapped to underlying storage. Thus, for example, one logical address is represented by mapping pointer 48-a that points to BVS 50(1), which points to an underlying data extent 52(1) that stores data of the block of the logical address. A block is the fundamental unit of storage at which persistent storage 44 stores data. Typically a block is 4 kilobytes or 8 kilobytes in size, although block sizes vary from system to system. In some embodiments, each data extent 52 is an actual block of the standardized size. In other embodiments, each data extent 52 may be smaller than or equal to the standard block size, if compression is used.

As depicted, two logical block addresses may share the same underlying data. Thus, logical addresses represented by mapping pointers 48-b, 48-c both point to a shared BVS 50(2), that is backed by data extent 52(2). Each BVS 50 may store a pointer to a data extent 52 as well as a digest (not depicted), which is a hash of the data of the block backed by the data extent 52(2). In addition, each BVS 50 may also store a reference count (not depicted) so that it can be determined how many blocks share a single data extent 52 for garbage collection purposes.

Deduplication DB 54 (which may be arranged as a key-value store) stores a set of entries, each of which maps a digest 56 to a pointer 58 that points to a particular BVS 50. This allows a processing node 32 to determine whether a newly-ingested block is already stored in persistent storage 44, and which BVS 50 (and ultimately, which underlying data extent 52) it should be associated with.

Memory 40 may be any kind of digital system memory, such as, for example, random access memory (RAM). Memory 40 stores an operating system (OS, not depicted) in operation (e.g., a Linux, UNIX, Windows, MacOS, or similar operating system). Memory 40 also stores a hashing module 65, an assignment module 76 that employs an ownership model 77, a deduplication module 78, and other software modules which each execute on processing circuitry 36 to fulfill data storage requests (e.g., write requests 62, 62′) which are either received from hosts or locally-generated.

Memory 40 also stores a cache portion 60 for temporarily storing data storage requests (e.g., write requests 62, 62′), a locally-cached portion 80, 80′ of the deduplication DB 54, and various other supporting data structures. Memory 40 may be configured as a collection of memory pages 69, each of which has a standard page size, as is known in the art. For example, the page size may be 4 kilobytes, 8 kilobytes, etc. In some example embodiments, the page size is equal to the block size.

Memory 40 may also store various other data structures used by the OS, I/O stack, hashing module 65, assignment module 76, deduplication module 78, and various other applications (not depicted).

In some embodiments, memory 40 may also include a persistent storage portion (not depicted). Persistent storage portion of memory 40 may be made up of one or more persistent storage devices, such as, for example, magnetic disks, flash drives, solid-state storage drives, or other types of storage drives. Persistent storage portion of memory 40 or persistent storage 44 is configured to store programs and data even while processing nodes 32 are powered off. The OS, applications, hashing module 65, assignment module 76, ownership model 77, and deduplication module 78 are typically stored in this persistent storage portion of memory 40 or on persistent storage 44 so that they may be loaded into a system portion of memory 40 upon a system restart or as needed. The hashing module 65, assignment module 76, and deduplication module 78, when stored in non-transitory form either in the volatile portion of memory 40 or on persistent storage drives 44 or in persistent portion of memory 40, each form a computer program product. The processing circuitry 36 running one or more applications thus forms a specialized circuit constructed and arranged to carry out the various processes described herein.

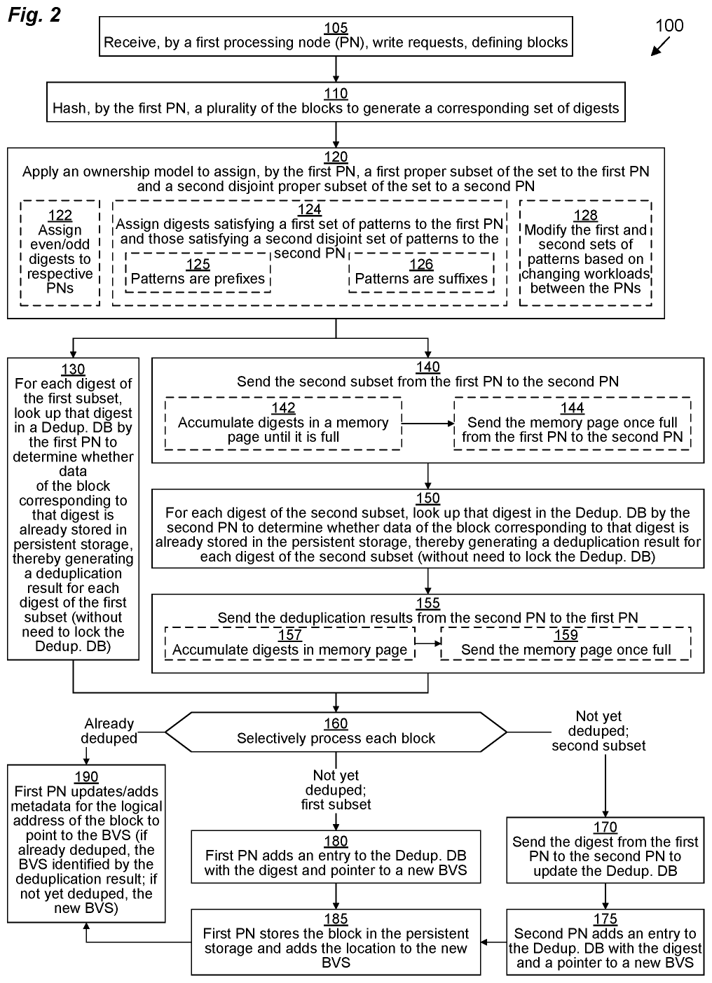

FIG. 2 illustrates an example method 100 performed by DSE 30 for efficiently managing inline deduplication of blocks 64 defined by incoming write requests 62, 62′ directed at each of two or more processing nodes 32 in accordance with various embodiments. It should be understood that any time a piece of software (e.g., I/O stack, hashing module 65, assignment module 76, or deduplication module 78) is described as performing a method, process, step, or function, what is meant is that a computing device (e.g., processing node 32) on which that piece of software is running performs the method, process, step, or function when executing that piece of software on its processing circuitry 36. It should be understood that one or more of the steps or sub-steps of method 100 may be omitted in some embodiments. Similarly, in some embodiments, one or more steps or sub-steps may be combined together or performed in a different order.

In step 105, a first processing (PN) node 32(A) receives write requests 62, each of which defines one or more blocks 64 of data to be stored at particular logical addresses within persistent storage 44. As depicted in the example of FIG. 1, a first write request includes two blocks 64-1 and 64-2, a second write request 62 includes one block 64-3, and a third write request 62 includes four blocks 64-4, 64-5, 64-6, 64-7.

Method 100 is primarily described in connection with the write requests 62 that are directed at the first PN 32(A). However, method 100 may also apply to write requests 62′ that are directed at the second PN 32(B), as differentiated throughout.

In step 110, hashing module 65 of PN 32(A) hashes the data of blocks 64 in the cache 60 to yield corresponding digests 68 (depicted as digests 68-1, 68-2, 68-3, 68-4, 68-5, 68-6, 68-7, which correspond to blocks 64-1, 64-2, 64-3, 64-4, 64-5, 64-6, 64-7, respectively).

Hashing module 65 applies a hashing algorithm such as, for example, SHA-2. In other embodiments, other hashing algorithms may also be used, such as, for example, SHA-0, SHA-1, SHA-3, and MD5. Such algorithms may provide bit-depths such as 128 bits, 160 bits, 172 bits, 224 bits, 256 bits, 384 bits, and 512 bits, for example. Preferably an advanced hashing algorithm with a high bit-depth is used to ensure a low probability of hash collisions between different blocks 64.

In the context of the inline deduplication and storage of blocks 64′ defined by write requests 62′ that are directed at the second PN 32(B), in step 110, PN 32(B) hashes the data of blocks 64′ in the cache 60′ to yield corresponding digests 68′ (depicted as digests 68′-1, 68′-2, 68′-3, 68′-4, which correspond to blocks 64′-1, 64′-2, 64′-3, 64′-4, respectively).

In step 120, assignment module 76 of PN 32(A) applies ownership model 77 to deterministically assign a first subset 66A (e.g., digests 68-1, 68-2, 68-3, 68-4) of the generated digests 68 to the first PN 32(A) and a second disjoint subset 66B (e.g., digests 68-5, 68-6, 68-7) of the generated digests 68 to the second PN 32(B). In some embodiments, additional disjoint subsets (not depicted) may be generated) for each additional PN 32 in the DSE 30. Assignment module 76 may use any deterministic ownership model 77, but typically ownership model 77 implements a fast assignment procedure with low computational complexity.

In some embodiments in which only two PNs 32(A), 32(B) are used, step 120 includes sub-step 122, in which the ownership model 77 relies on the parity of each digest, assigning even digests 68 to one subset 66A and odd digests to the other subset 66B (or vice-versa). This ownership model 77 is simple because only the last digit of each digest 68 need be examined.

In other embodiments, step 120 includes sub-step 124, in which assignment module 76 applies ownership model 77 to assign digests 68 satisfying a first set of patterns to the first PN 32(A) and those satisfying a second disjoint set of patterns to the second PN 32(B) (and, additional patterns being assigned to additional PNs 32, if present). For example, in some embodiments, the patterns may be matched at a terminal end of each digest, such as (sub-sub-step 125) at the beginning (i.e., a prefix) or (sub-sub-step 126) at the end (i.e., a suffix). Thus, for example, in the context of sub-sub-step 125, a 3-bit prefix pattern may be used, with prefix patterns 000, 001, 010, and 011 assigned to PN 32(A) and prefix patterns 100, 101, 110, and 111 assigned to PN 32(B).

In some embodiments, in optional sub-step 128, assignment module 76 may dynamically alter the pattern assignments used in sub-step 124 based on changing workloads between the PNs 32. Thus, the example assignment of the 3-bit prefix patterns above may be a default assignment assuming an equal workload between PNs 32(a), 32(B). However, if, at another point in time, PN 32(A) has 37.5% of the workload instead of 50%, one prefix pattern (e.g., 011) may be reassigned from 32(A) to 32(B) so that 37.5% (three out of eight) of the prefix patterns are assigned to PN 32(A). It should be understood that embodiments that use longer patterns allow for more granularity in reassignment based on workload. Thus, in some embodiments, prefixes of a 10-bit length may be used, allowing for a granularity of about 0.1%.

In the context of the inline deduplication and storage of blocks 64′ defined by write requests 62′ that are directed at the second PN 32(B), PN 32(B), in step 120, PN 32(B) deterministically assigns a first subset 66A′ (e.g., digests 68′-1, 68′-2) of the generated digests 68′ to the first PN 32(A) and a second disjoint subset 66B′ (e.g., digests 68′-3, 68′-4) of the generated digests 68′ to the second PN 32(B).

After step 120, step 130 may be performed in parallel or concurrently with steps 140, 150, and 155.

In step 130, for each digest 68 of the first subset 66A, deduplication module 78 of PN 32(A) looks up that digest 68 in deduplication DB 54 to generate a deduplication result 72 based on whether data of the block 64 corresponding to that digest 68 is already stored in persistent storage 44. In some embodiments, PN 32(A) locally caches entries of the deduplication DB 54 that are assigned to PN 32(A) (e.g., entries whose digests 56 satisfy a first pattern 57(A)) within locally-cached deduplication DB portion 80 for faster access. Any updates to the locally-cached deduplication DB portion 80 may eventually be synchronized (step 82) to the persistent deduplication DB 54. If the digest 68 is found in the deduplication DB 54 (or the locally-cached version 80, in such embodiments), then that means that the block 64 corresponding to that digest 68 is already stored in persistent storage 44, and the corresponding BVS pointer 58 is stored within the corresponding deduplication result 72. Otherwise, a deduplication miss occurs, which means that the block 64 corresponding to that digest 68 might not yet be stored in persistent storage 44 (although if the deduplication DB 54 is not 100% comprehensive, the block 64 might actually already be stored in persistent storage 44), and the corresponding deduplication result 72 indicates a lack of a corresponding BVS pointer 58 (e.g., by storing a NULL or invalid value). It should be understood that there is no need to lock the entire deduplication DB 54 because each PN 32 is configured to only access entries indexed by its assigned digests 68, and the assignment of digests 68 do not overlap. In some embodiments, deduplication DB 54 is arranged as a set of buckets (not depicted), each bucket being assigned to store digests 56 that have a particular pattern 57 (e.g., a prefix). In some embodiments, each bucket may be arranged as one or more blocks of storage 44 (or memory pages within memory 40). Thus, in embodiments in which sub-step 124 and sub-sub-step 125 are practiced, each bucket is only ever accessed by one PN 32 at a time, since all digests 56 within a bucket have the same (prefix) pattern 57 and therefore are assigned to the same PN 32. This arrangement avoids the need to use locks entirely, even while synchronizing the locally-cached deduplication DB portions 80, 80′ to the deduplication DB 54 in persistent storage 44, since any block (which is typically the smallest unit through which persistent storage 44 can be accessed) of the deduplication DB 54 is accessed by only one PN 32 at a time.

In the context of the inline deduplication and storage of blocks 64′ defined by write requests 62′ that are directed at the second PN 32(B), in step 130, for each digest 68′ of the subset 66B′, deduplication module 78 of PN 32(B) looks up that digest 68′ in deduplication DB 54, thereby generating corresponding deduplication results 72′ for each digest 68′ of the subset 66B′.

In step 140, deduplication module 78 of PN 32(A) sends a digest lookup message 70 including the digests 68 of the second subset 66B to the second PN 32(B) over inter-node communications link 39 (or across a network via network interface circuitry 34 if the PNs 32(A), 32(B) are in different enclosures). In some embodiments, step 140 may be performed by performing sub-steps 142 and 144. In sub-step 142, as each digest 68 is created and assigned, the digests 68 that are assigned to set 66B accumulate within a memory page 69 until that page 69 is full. Thus, for example, if each digest 68 is 512 bits (i.e., 64 bytes) and the system page size is 4 kilobytes, once sixty-four (or fewer, if a header is used) digests 68 have accumulated in memory page 69, that memory page 69 becomes full, at which operation proceeds to sub-step 144. In sub-step 144, deduplication module 78 of PN 32(A) inserts that memory page 69 into digest lookup message 70 to be sent to the second PN 32(B). This accumulation allows for efficiency of communication.

In the context of the inline deduplication and storage of blocks 64′ defined by write requests 62′ that are directed at the second PN 32(B), in step 140, deduplication module 78 of PN 32(B) sends a digest lookup message 70′ including the digests 68′ of the subset 66A′ to the first PN 32(A) over inter-node communications link 39 (or across a network via network interface circuitry 34 if the PNs 32(A), 32(B) are located in different apparatuses).

Then, in step 150, upon PN 32(B) receiving digest lookup message 70, for each digest 68 of the second subset 66B contained within the digest lookup message 70, deduplication module 78 of PN 32(B) looks up that digest 68 in deduplication DB 54 to determine whether data of the block 64 corresponding to that digest 68 is already stored in persistent storage 44, thereby generating a deduplication result 72 for each digest 68 of the second subset 66B. In some embodiments, PN 32(B) locally caches entries of the deduplication DB 54 that are assigned to PN 32(B) (e.g., entries whose digests 56 satisfy a second pattern 57(B)) within locally-cached deduplication DB portion 80′ for faster access. Any updates to the locally-cached deduplication DB portion 80′ may eventually be synchronized (step 82′) to the persistent deduplication DB 54. If the digest 68 is found in the deduplication DB 54 (or locally-cached version 80′), then that means that the block 64 corresponding to that digest 68 is already stored in persistent storage 44, and the corresponding BVS pointer 58 is stored within the corresponding deduplication result 72. Otherwise, a deduplication miss occurs, which means that the block 64 corresponding to that digest 68 might not yet be stored in persistent storage 44, and the corresponding deduplication result 72 indicates a lack of a corresponding BVS pointer 58 (e.g., by storing a NULL or invalid value). It should be understood that, as noted above there is no need to lock the entire deduplication DB 54 because each PN 32 is configured to only access entries indexed by its assigned digests 68, and the assignment of digests 68 do not overlap.

In the context of the inline deduplication and storage of blocks 64′ defined by write requests 62′ that are directed at the second PN 32(B), in step 150, upon PN 32(A) receiving digest lookup message 70′, for each digest 68′ of the subset 66A′ contained within the digest lookup message 70′, deduplication module 78 of PN 32(A) looks up that digest 68′ in deduplication DB 54 to determine whether data of the block 64 corresponding to that digest 68′ is already stored in persistent storage 44, thereby generating a deduplication result 72′ for each digest 68′ of the subset 66A′.

Then, in step 155, deduplication module 78 of PN 32(B) sends a deduplication result message 74 including the deduplication results 72 (e.g., deduplication results 72-5, 72-6, 72-7) of the second subset 66B to the first PN 32(A) over inter-node communications link 39 (or across a network via network interface circuitry 34 if the PNs 32(A), 32(B) are located in different apparatuses). In some embodiments, step 155 may be performed by performing sub-steps 157 and 159. In sub-step 157, as each deduplication result 72 is generated, those deduplication results 72 accumulate within a memory page 69 until that page 69 is full. In sub-step 159, deduplication module 78 of PN 32(B) inserts that memory page 69 into deduplication result message 74 to be sent to the first PN 32(A). This allows for efficiency of communication.

In the context of the inline deduplication and storage of blocks 64′ defined by write requests 62′ that are directed at the second PN 32(B), in step 155, PN 32(A) sends a deduplication result message 74′ including the deduplication results 72′ (e.g., deduplication results 72′-1, 72′-2) of the subset 66BA′ to the second PN 32(B) over inter-node communications link 39 (or across a network via network interface circuitry 34 if the PNs 32(A), 32(B) are located in different apparatuses).

In step 160, deduplication module 78 of PN 32(A) selectively begins to process each cached block 64 based on whether its corresponding deduplication result 72 indicates that data of that block 64 can already be found in persistent storage 44 (operation proceeds directly to step 190), and, if not, whether its corresponding digest 68 is part of the first subset 66A (operation proceeds with step 180) or the second subset 66B (operation proceeds with step 170).

In step 180, deduplication module 78 of PN 32(A) creates a new BVS 50 and adds an entry to the deduplication DB 54 (and locally-cached version 80, in some embodiments) indexed by the digest 68 of the block 64 being written. The added entry includes a pointer 58 to the new BVS 50 that was just added. Operation then proceeds with step 185.

In step 170, deduplication module 78 of PN 32(A) sends the digest 68 of the block 64 being written to the other PN 32(B) in order to effect the update to the deduplication DB 54. This step may be performed similarly to step 140 (e.g., with sub-steps similar to sub-steps 142, 144). Then, in step 175, deduplication module 78 of PN 32(B) (or, in some embodiments deduplication module 78 of PN 32(A)), creates a new BVS 50 and deduplication module 78 of PN 32(B) adds an entry to the deduplication DB 54 (and locally-cached version 80′, in some embodiments) indexed by the digest 68 of the block 64 being written. The added entry includes a pointer 58 to the new BVS 50 that was just added. Operation then proceeds with step 185.

In step 185, deduplication module 78 of PN 32(A) stores the block 84 being written in the persistent storage as a new data extent 52 (either uncompressed or compressed) and adds the location to the new BVS that was just created in step 180 or 175. Operation then proceeds to step 190.

In step 190, deduplication module 78 of PN 32(A) updates (if performed in response to step 185) or adds (if performed directly in response to step 160) metadata for the logical address of the block 64 being written to point to the new BVS 50 that was just created in step 180 or 175 (if performed in response to step 185) or the BVS 50 pointed to by the deduplication result 72 for that block 64 (if performed directly in response to step 160). This is inserted as the mapping pointer 48 at the appropriate address within logical address mapping layer 46.

It should be understood that for a cached block 64 whose corresponding deduplication result 72 indicates that data of that block 64 has already been stored in persistent storage 44, since operation proceeded directly with step 190, the data of that block 64 is not written to persistent storage 44 as part of processing that block 64 because it is already stored there.

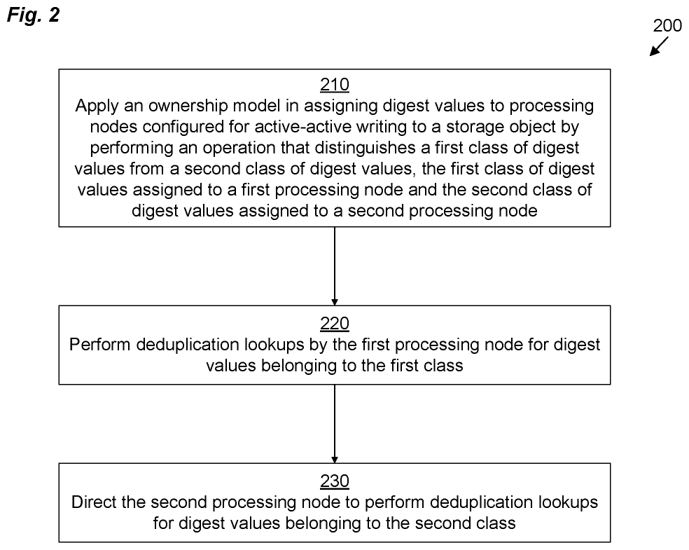

FIG. 3 illustrates an example method 200 performed by DSE 30 for efficiently managing deduplication of blocks 64 in accordance with various embodiments. It should be understood that example method 200 may overlap with method 100.

In step 210, DSE 30 applies ownership model 77 in assigning digest values 68 to PNs 32 configured for active-active writing to a storage object (e.g., a logical disk or set of logical disks mapped by logical address mapping layer 46) by performing an operation (e.g., a pattern-matching or other mathematical assignment procedure) that distinguishes a first class of digest values 68 (e.g., a class including set 66A and/or set 66A′) from a second class of digest values 68 (e.g., a class including set 66B and/or set 66B′), the first class of digest values 68 assigned to a first PN 32(A) and the second class of digest values assigned to a second PN 32(B). In some embodiments, each class is defined by a set of patterns 57 assigned to a particular PN 32.

In some embodiments, step 210 may be performed by first PN 32(A). In other embodiments, step 210 may be performed by second PN 32(B) or by some other entity.

In step 220, the first PN 32(A) performs deduplication lookups into the deduplication DB 54 (or its locally-cached portion 80) for digest values 68 belonging to the first class (e.g., digests 68, 68′ belonging to set 66A and/or 66A′). It should be noted that the language “performing deduplication lookups by the first processing node for digest values belonging to the first class” is defined to the exclusion of performing deduplication lookups by the first processing node for digest values belonging to the second class (or a third class assigned to another processing node 32).

In step 230, the first PN 32(A) directs the second PN 32(B) to perform deduplication lookups into the deduplication DB 54 (or its locally-cached portion 80′) for digest values 68 belonging to the second class (e.g., digests 68, 68′ belonging to set 66B and/or 66B′). It should be noted that the language “directing the second processing node to perform deduplication lookups for digest values belonging to the second class” is defined to the exclusion of performing deduplication lookups by the second processing node for digest values belonging to the first class (or a third class assigned to another processing node 32).

Thus, techniques have been presented for operating an active-active system 30 employing deduplication in a manner that avoids deficiencies both due to locking and reduced storage efficiency. This may be accomplished by assignment module 76 applying an ownership model 77 that deterministically assigns digests 68 to particular processing nodes 32(A), 32(B). Upon receiving (step 105) any new block 64 for ingest, a processing node 32(A) hashes it to produce a digest 68 (step 110) and determines (steps 120, 210), in accordance with the ownership model 77, whether it is the owner of the digest 68 or some other node (e.g., processing node 32(B)) is the owner. If that processing node 32(A) owns the digest 68, it looks up the digest 68 in a shared digest database 54 (or locally-cached portion 80) (steps 130, 220) and continues performing deduplication (steps 160, 180, 185, 190) on the block 64 based on what is found in the database 54, 80. If that processing node 32(A) is not the owner of the digest 68, that processing node 32(A) instead forwards (steps 140, 230) the digest 68 to another processing node 32(B) that is the owner. That other processing node 32(B) then looks up the digest 68 in the shared digest database 54 (or locally-cached portion 80′) (step 150). In this fashion, the workload associated with digest lookups is divided among the processing nodes 32 in accordance with the ownership model 77. Each node 32 is permitted to limit its cached digests (e.g., within locally-cached portions 80, 80′) to only those digests 68 for which it is the owner, thus reducing overall utilization of memory 40. A further improvement can be made by dynamically modifying the ownership model 77 to account for changing processor availability of the various processing nodes 32 (sub-step 128). Another improvement can be made by accumulating (sub-step 142) several digests 68 to be forwarded until a memory page 69 has been filled with such digests 68, allowing for efficient communications between the processing nodes 32.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Further, although ordinal expressions, such as “first,” “second,” “third,” and so on, may be used as adjectives herein, such ordinal expressions are used for identification purposes and, unless specifically indicated, are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Although certain embodiments are disclosed herein, it is understood that these are provided by way of example only and that the invention is not limited to these particular embodiments.

While various embodiments have been particularly shown and described, it will be understood by those skilled in the art that various changes in form and details may be made therein without departing from the spirit and scope of the appended claims.

For example, although various embodiments have been described as being methods, software embodying these methods is also included. Thus, one embodiment includes a tangible non-transitory computer-readable storage medium (such as, for example, a hard disk, a floppy disk, an optical disk, flash memory, etc.) programmed with instructions, which, when performed by a computer or a set of computers, cause one or more of the methods described in various embodiments to be performed. Another embodiment includes a computer that is programmed to perform one or more of the methods described in various embodiments.

Furthermore, it should be understood that all embodiments which have been described may be combined in all possible combinations with each other, except to the extent that such combinations have been explicitly excluded.

Finally, even if a technique, method, apparatus, or other concept is specifically labeled as “background,” Applicant makes no admission that such technique, method, apparatus, or other concept is actually prior art under 35 U.S.C. § 102 or 35 U.S.C. § 103, such determination being a legal determination that depends upon many factors, not all of which are known to Applicant at this time.

What is claimed is:

1. A method of performing deduplication, the method comprising:
applying an ownership model in assigning digest values to processing nodes configured for active-active writing to a storage object by performing an operation that distinguishes a first class of digest values from a second class of digest values, the first class of digest values assigned to a first processing node and the second class of digest values assigned to a second processing node;
performing deduplication lookups by the first processing node for digest values belonging to the first class; and
directing the second processing node to perform deduplication lookups for digest values belonging to the second class.

2. The method of claim 1 wherein directing the second processing node to perform deduplication lookups for digest values belonging to the second class includes:
accumulating digest values belonging to the second class into a memory page until the memory page is full; and
sending the memory page across a communications link from the first processing node to the second processing node once the memory page is full.

3. The method of claim 1 wherein the method further comprises, in response to directing the second processing node to perform deduplication lookups for digest values belonging to the second class:
performing deduplication lookups by the second processing node for digest values belonging to the second class; and
sending deduplication matches generated by the deduplication lookups performed by the second processing node to the first processing node.

4. The method of claim 3,
wherein performing deduplication lookups by the first processing node includes searching a first cached portion of a shared deduplication database, the first cached portion being stored on the first processing node; and
wherein performing deduplication lookups by the second processing node includes searching a second cached portion of the shared deduplication database, the second cached portion being stored on the second processing node.

5. The method of claim 4,
wherein the shared deduplication database is stored on persistent storage shared by the first and second processing nodes; and
wherein the method further comprises synchronizing the shared deduplication database with the first cached portion of the shared deduplication database and the second cached portion of the shared deduplication database.

6. The method of claim 1 wherein assigning digest values to processing nodes includes:
assigning digest values satisfying a first set of patterns to the first processing node; and
assigning digest values satisfying a second disjoint set of patterns to the second processing node.

7. The method of claim 6 wherein each digest values satisfying the first set of patterns includes a prefix of predefined length that satisfies the first set of patterns and each digest values satisfying the second set of patterns includes a prefix of the predefined length that satisfies the second set of patterns.

8. The method of claim 7 wherein performing deduplication lookups is done with reference to a shared database, the database being arranged as a set of buckets, each bucket being assigned to store digest values that have a corresponding prefix of the predefined length.

9. The method of claim 7 wherein the method further includes modifying the first set of patterns and the second set of patterns based on changing workloads between the first and second processing nodes.

10. The method of claim 1 wherein assigning digest values to processing nodes includes:
assigning odd digest values to one of the first processing node and the second processing node; and
assigning even digest values to the other of the first processing node and the second processing node.

11. The method of claim 1 wherein the method further comprises:
receiving a set of write requests at the first processing node directed at addresses within the storage object, data to be written to each address defining a block;
hashing, by the first processing node, the blocks defined by the set of write requests to generate a plurality of digest values;
applying the ownership model by the first processing node to the plurality of digest values, thereby creating a first set of digest values belonging to the first class and a second set of digest values belonging to the second class; and
fulfilling the set of write requests by the first processing node, including, for each digest value of the first or second set that produced a deduplication match from deduplication lookups by the first or second processing node, respectively, adjusting metadata of the storage object without writing, to persistent storage, the block from which that digest value was created.

12. The method of claim 11 wherein the method further comprises:
receiving another set of write requests at the second processing node directed at addresses within the storage object;
hashing, by the second processing node, the blocks defined by the other set of write requests to generate another plurality of digest values;
applying the ownership model by the second processing node to the other plurality of digest values, thereby creating a third set of digest values belonging to the first class and a fourth set of digest values belonging to the second class;
performing deduplication lookups by the second processing node for digest values belonging to the fourth set;
by the second processing node, directing the first processing node to perform deduplication lookups for digest values belonging to the third set; and
fulfilling the other set of write requests by the second processing node, including, for each digest value of the third or fourth set that produced a deduplication match from deduplication lookups by the first or second processing node, respectively, adjusting metadata of the storage object without writing, to persistent storage, the block from which that digest value was created.

13. The method of claim 1,
wherein the operation that distinguishes the first class of digest values from the second class of digest values further distinguishes the first class of digest values and the second class of digest values from a third class of digest values, the third class of digest values assigned to a third processing node; and
wherein the method further comprises performing deduplication lookups by the third processing node for digest values belonging to the third class.

14. A system comprising:
persistent storage storing a storage object;
a first processing node, including processing circuitry and memory, configured to read to and write from the persistent storage;
a second processing node, including processing circuitry and memory, configured to read to and write from the persistent storage, the first and second processing nodes configured for active-active writing to the storage object; and
a communications link between the first and second processing nodes;
wherein the first processing node is configured to:
apply an ownership model in assigning digest values to processing nodes by performing an operation that distinguishes a first class of digest values from a second class of digest values, the first class of digest values assigned to the first processing node and the second class of digest values assigned to the second processing node;
perform deduplication lookups for digest values belonging to the first class; and
direct the second processing node to perform deduplication lookups for digest values belonging to the second class; and
wherein the second processing node is configured to:
apply the ownership model in assigning digest values to processing nodes;
perform deduplication lookups for digest values belonging to the second class; and
direct the first processing node to perform deduplication lookups for digest values belonging to the first class.

15. A computer program product comprising a non-transitory computer-readable storage medium storing a set of instructions, which, when executed by processing circuitry of a first processing node of a data storage environment, cause the first processing node to:
apply an ownership model in assigning digest values to processing nodes of the data storage environment configured for active-active writing to a storage object by performing an operation that distinguishes a first class of digest values from a second class of digest values, the first class of digest values assigned to the first processing node and the second class of digest values assigned to a second processing node of the data storage environment;
perform deduplication lookups for digest values belonging to the first class; and
direct the second processing node to perform deduplication lookups for digest values belonging to the second class.
